(19) United States
(12) Patent Application Publication
(10) Pub. No.: US 2015/0327451 A1
(43) Pub. Date: Nov. 19, 2015

(54) Hydroponic Cultivation Kit

(71) Applicant: Green Space Zouen Co., Ltd., Kobe-shi, Hyogo (JP)

(72) Inventor: Shigeki Koyama, Kobe-shi (JP)

(73) Assignee: Green Space Zouen Co., Ltd., Kobe-shi, Hyogo (JP)

(21) Appl. No.: 14/646,383

(22) PCT Filed: May 14, 2014
(86) PCT No.: PCT/JP2014/062846

§ 371 Date: May 20, 2015

(30) Foreign Application Priority Data
May 23, 2013 (JP) 2013-109420

(51) Int. Cl. A01G 31/02; A01K 63/00; A01G 27/02

(52) U.S. Cl. CPC A01G 31/02; A01G 27/02; A01K 63/003

(57) ABSTRACT

A hydroponic cultivation kit enables taking a plant seedling, intact in its planting soil, out of a growth pot and replanting it. Within a growth pot prepared in advance, a plant seedling or the like planted in soil is taken out of the growth pot together with the soil and cultivated in a culture solution. The hydroponic cultivation kit is furnished with: foam stone for surrounding the soil periphery of the plant taken out from the growth pot; a retaining mesh pot for retaining the plant with its soil periphery surrounded by the foam stone; and a buoyant member for floating the mesh pot in culture solution inside a water-tank unit. The mesh pot has perforations such as to prohibit the foam stone from passing through it, yet meanwhile permit passage of roots jutting out from the plant.

### TECHNICAL FIELD

The present invention relates to hydroponic cultivation kits, and is especially suited as a hydroponic cultivation kit for home gardening.

Hydroponic cultivation allows for easy observation of decorative as well as edible plants—of how they are being raised—and therefore the trend has been toward its adoption both as a pastime and for practical benefits. Devices for hydroponic cultivation include those that supply a culture solution directly to a cultivation tank, instead of storing it in a separate liquid reservoir, and dissolve in essential nutrients and adjust the preparation to a concentration suited to growing produce. With the cultivation tank alone being sufficient, making circulation pumps and plumbing unnecessary, this device is small-scale and simple, such as to be relatively easy to handle and therefore ideally suited to general home garden applications.

With this type of hydroponic cultivation device, however, supply of the culture solution to the cultivation tank is not carried out automatically. Moreover, the design has the cultivation bed positionally fixed. Consequently, a problem has been that when the culture solution runs low as the plant grows, the cultivation bed separates at a gap from the culture solution, and in cases in which the roots are short, such as with a young seedling, it often happens that the roots no longer touch the culture solution and, exposed to the air, wither and die. As a countermeasure, water-level gauges have been installed on the cultivation tanks, but for persons who are not plant-rearing specialists, supplementing the culture solution with the water-level gauge as a yardstick is difficult, and what is more, the water-level gauge is prone to become murky from aquatic mineral deposits etc., on account of which managing the culture solution has tended to be unreliable.

Therein, simple hydroponic cultivation devices for general home gardening, made up of a cultivation tank that stores culture solution, a pump that dissolves oxygen into the culture solution, and a cultivation bed where plants are set in, and in which the cultivation bed is made to float to the culture solution surface and the cultivation tank is furnished with a cross-sectional form that restricts subsidence of the cultivation bed when the culture solution has run low to a given water level, have been developed (cf., for example, Patent Document 1).

In that regard, it has been mentioned that a sunken state of the cultivation bed—that is, the fluid surface of the culture solution—is apparent, enabling novices to determine insufficiency of culture solution at a glance, thanks to which culture solution management is extremely easy, and culture solution can be reliably secured if it has reached that state.

### PRECEDENT TECHNICAL LITERATURE

### Patent Documents

Patent Document 1: Japanese Utility Model Pub. No. S63-199548

### SUMMARY OF INVENTION

### Issues Invention is to Address

Here, it is noteworthy that when a plant is raised from seed it takes at minimum some two weeks to be able to observe transformation, but when a plant is raised from a seedling, transformation can be observed immediately. Such a plant seedling 9 is sold commercially planted in soil in a growth pot (polyethylene film pot) 3a, as illustrated in FIG. 7, for example. Since the breathability of the growth pot 3A is poor, however, making it prone to getting musty, it is preferable that a plant seedling 9 planted in it should be transplanted as soon as possible.

On that account, with the above-noted Patent Document 1, the plant seedling 9 is taken out of the growth pot 3a, and soil 3 clinging to its roots is all stripped off, whereupon the seedling is replanted in a plant-setting hole piercing a cultivation bed made of polystyrene foam. Yet the fact that the plant seedling 9 is replanted upon taking it out of the growth pot 3a and stripping off all of the soil 3 clinging to its roots can end up injuring the roots.

An object of the present invention, brought about taking such circumstances into consideration, is to afford a hydroponic cultivation kit that enables taking a plant seedling, intact in its planting soil, out of a growth pot and replanting it.

A hydroponic cultivation kit involving a first among modes of the present invention is a hydroponic cultivation kit configured so as to cultivate in a culture solution a soil-clung plant—being, within a growth pot prepared in advance, a plant seedling planted in soil or an in-soil decorative plant from a cutting—taken out of the growth pot together with the soil, and is furnished with: an encompassing material for surrounding the soil periphery of the plant taken out from the growth pot; a retaining member for retaining the plant with its soil periphery surrounded by the encompassing material; and a buoyant member for floating the retaining member in culture solution inside a water-tank unit; and is characterized in that the retaining member has perforations such as to prohibit the encompassing material from passing through it, yet meanwhile permit passage of roots jutting out from the plant.

Since this configuration provides the encompassing material for surrounding the soil periphery of a plant taken out from its growth pot, the retaining member for retaining the plant with its soil periphery surrounded by the encompassing material, and the buoyant member for floating the retaining member in culture solution inside a water-tank unit, with the retaining member having perforations such as to prohibit the encompassing material from passing through it while permitting passage of roots jutting out from the plant, a plant seedling as-is planted in soil or a decorative plant intact in-soil as a cutting can be taken out from the growth pot and replanted. Risk of the plant roots getting injured is thereby eliminated. Thus, as the plant roots extend within the culture solution, the buoyant member rises or falls with increase or decrease of the culture solution, whereby the present amount of culture solution can be known. Then at an appropriate timing, the culture solution can be supplemented. A benefit in configuring in this way is that the transformation in the growing of a plant can be observed directly and easily.

It is to be noted that if the retaining member is vertically long compared to the buoyant member, when such buoyant member is floated on the cultivation solution, it is liable to be unstable. Therein, preferable is a hydroponic cultivation kit involving a second mode, in which the upper portion alone of the retaining member can be supported by the buoyant member.

According to this configuration, with the plant in a stabilized state since the upper portion alone of the retaining member is supportable by the buoyant member, the roots can extend out into the culture solution.

Also preferable is a hydroponic cultivation kit involving a third mode, in which a stop means for staying the buoyant member is provided in the upper portion of the water-tank unit.

According to this configuration, since stop means for staying the buoyant member in the upper portion of the water-tank unit is provided, it is possible to prevent excessive tilting of the plant.

Also, if organic matter (algae) breeds within the culture solution, it will flourish in sunlight, leading to oxygen shortage throughout the culture solution. Therein, preferable is a hydroponic cultivation kit involving a fourth mode, in which an air supply means for supplying air into the culture solution is provided.

According to this configuration, since an air supply means for supplying air into the culture solution is provided, the culture solution can be replenished with oxygen by the supply of air.

Also preferable is a hydroponic cultivation kit involving a fifth mode, which has the water-tank unit be enclosed in an opaque member, and at the same time the opaque member along at least a front face of the water-tank unit be either removable or openable/closable.

Since this configuration is rendered having the water-tank unit be enclosed in an opaque member, and at the same time the opaque member along at least a front face of the water-tank unit be either removable or openable/closable, the shielding of light puts an end to organic matter (algae) breeding such that the culture solution spoils. Further, either warmth or cold can be kept in, such that the temperature inside the water tank can be maintained practically constant. What is more, how the roots of the plant are spreading and similar observations may be made.

Also, when refilling with culture solution and in similar situations, there is a danger that the encompassing material within the retaining member will scatter. Therein, preferable is a hydroponic kit involving a sixth mode, in which the upper face of the retaining member is covered with a dual-split lid, and at the same time the lid is furnished with a soft block that allows the stalk of a plant to penetrate through it.

According to this configuration, since the upper face of the retaining member is covered with a dual-split lid, and at the same time the lid is furnished with a soft block that allows the stalk of a plant to penetrate through it, scattering of the encompassing material within the retaining member may be prevented. Furthermore, there is no injury to the stalk of a plant where it penetrates through the lid.

Also preferable is a hydroponic cultivation kit involving a seventh mode, which has fish rearing within the culture solution inside the water-tank unit be possible.

This configuration, in having the rearing of fish within the culture solution inside the water-tank unit be possible, enables an enhanced viewing experience.

### Effects of Invention

According to a hydroponic cultivation kit involving a first among modes of the present invention, it is furnished with an encompassing material for surrounding the soil periphery of a plant taken out from its growth pot, a retaining member for retaining the plant with its soil periphery surrounded by the encompassing material, and a buoyant member for floating the retaining member in culture solution inside a water-tank unit, wherein the retaining member has perforations such as to prohibit the encompassing material from passing through it, yet meanwhile permit passage of roots jutting out from the plant, and therefore a plant seedling as-is planted in soil or a decorative plant intact in-soil as a cutting can be taken out from the growth pot and replanted. Risk of the plant roots getting injured is thereby eliminated. Thus, as the plant roots extend within the culture solution, the buoyant member rises or falls with the increase or decrease of the culture solution, whereby the present amount of culture solution can be known. Then at an appropriate timing the culture solution can be supplemented. A benefit in configuring in this way is that the transformation in the growing of a plant can be observed directly and easily.

### BRIEF DESCRIPTION OF DRAWINGS

FIG. 1 is a front view illustrating the overall configuration of a hydroponic cultivation kit involving Embodying Mode 1 of the present invention.

FIG. 2 is a plan view of the hydroponic cultivation kit involving present Embodying Mode 1.

FIG. 3 is a vertical section view of a mesh pot and a buoyant member involving present Embodying Mode 1.

FIG. 4A is a perspective view illustrating the overall configuration of an insulating member for a water-tank unit, and a lid for the mesh pot, involving Embodying Mode 1.

FIG. 4B is a sectional lateral view representing a partial makeup of the insulating member for the water-tank unit involving Embodying Mode 1.

FIG. 4C is a sectional front view representing a partial makeup of the mesh-pot lid involving Embodying Mode 1.

FIG. 5 is a front view illustrating the overall configuration of a hydroponic cultivation kit involving Embodying Mode 2 of the present invention.

FIG. 6 is a plan view of the hydroponic cultivation kit involving present Embodying Mode 2.

FIG. 7 is a sectional front view illustrating the overall configuration of a growth pot in which a plant seedling has been planted in soil.

### MODES FOR EMBODYING THE INVENTION

The present application is based on Japanese Pat. App. 2013-109420, filed in Japan by the present applicant on May 23, 2013, and the entirety of its content is by reference incorporated into the present application. Below, features of the present invention will be specifically described in accordance with the drawings. It should be understood that the following explanation is in order to facilitate an understanding of the present invention, but is not limited thereto. That is, modifications, embodying modes, and other examples based on the technical concepts of the present invention are included in the present invention.

### Embodying Mode 1

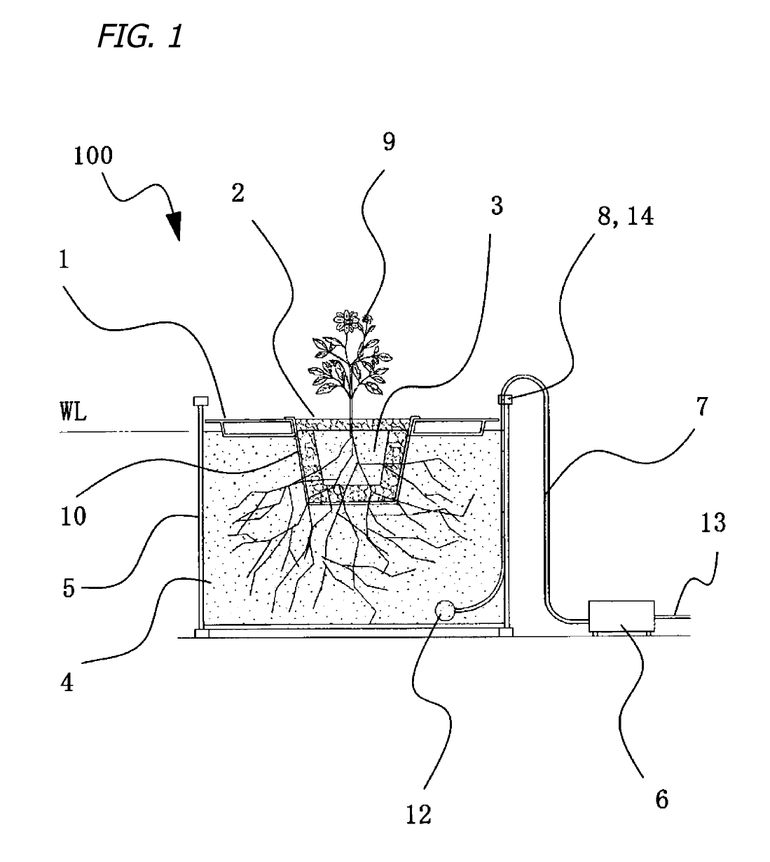

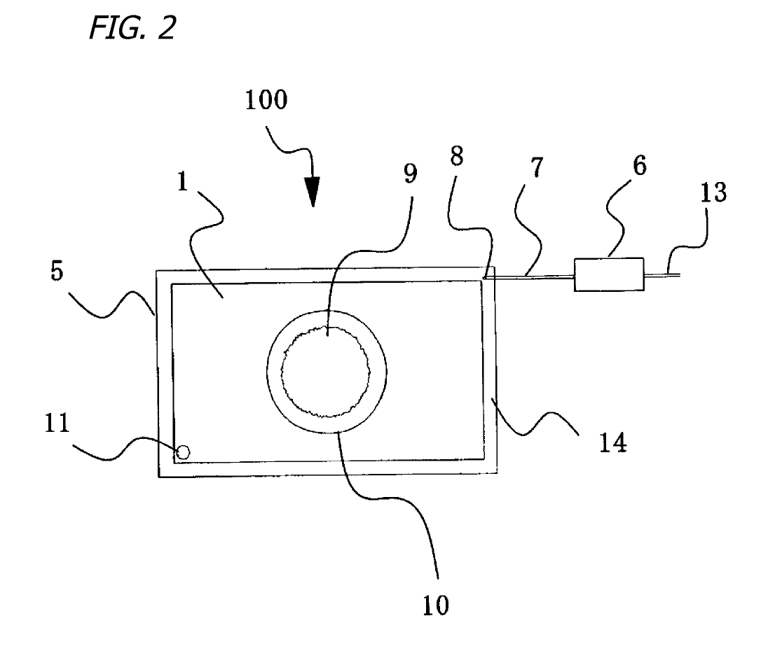

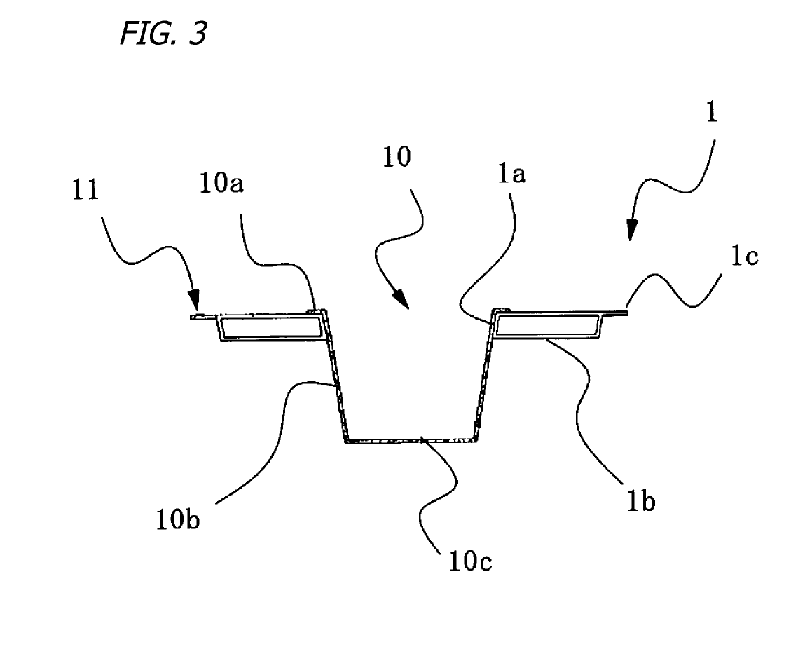

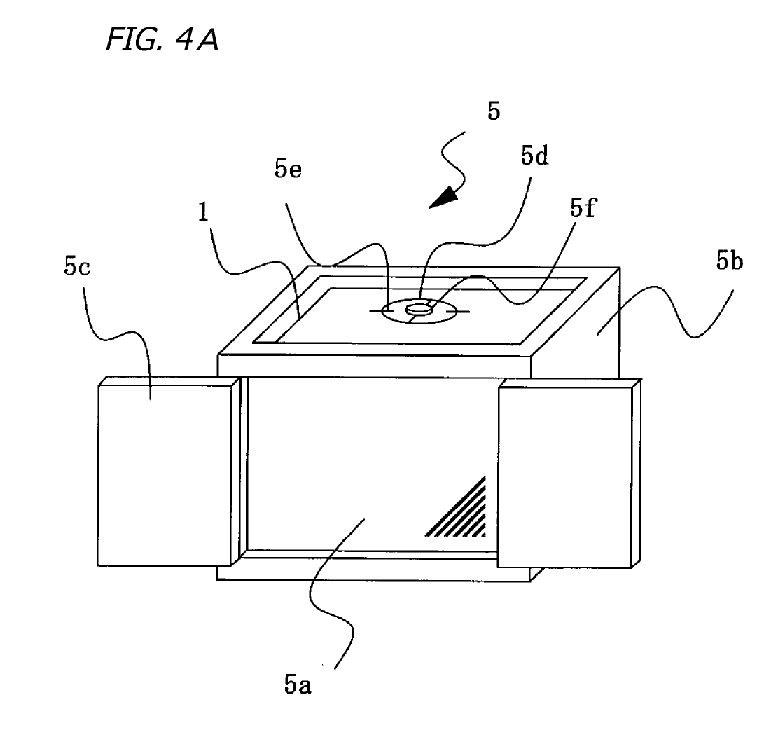

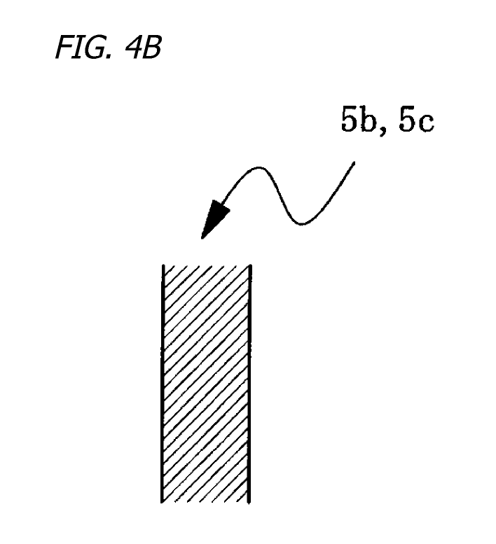

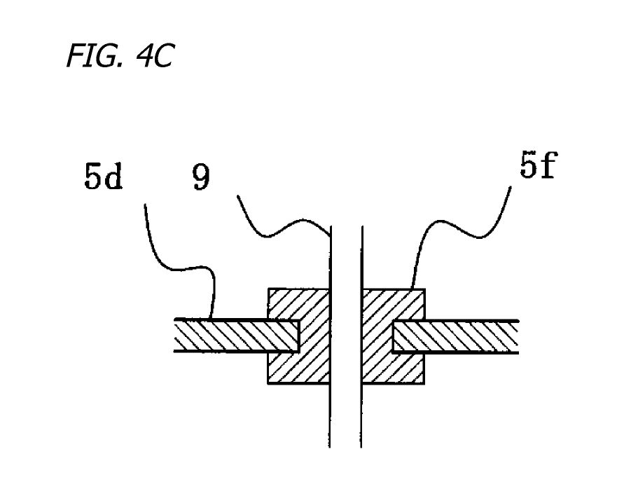

FIG. 1 is a front view illustrating the overall configuration of a hydroponic cultivation kit 100 involving Embodying Mode 1 of the present invention; FIG. 2 is a plan view thereof; FIG. 3 is a vertical section view of a mesh pot 10 and a buoyant member 1 involving present Embodying Mode 1; FIG. 4A is a perspective view illustrating the overall configuration of an insulating member 5c, 5b for a water-tank unit 5, and a lid 5d for the mesh pot 10 involving present Embodying Mode 1; FIG. 4B is a sectional lateral view representing a partial makeup of the insulating member 5c, 5b for the water-tank unit 5; FIG. 4C is a sectional front view representing a partial makeup of the mesh-pot lid 5d; and FIG. 7 is a sectional front view illustrating the overall configuration of a growth pot 3a in which a plant seedling 9 has been planted in soil.

The hydroponic cultivation kit 100, as indicated in FIG. 1 and FIG. 2, features contents 3 in a growth pot 3a, in which a plant seedling 9 has been planted in soil, being put into a mesh pot (corresponding to a retaining member) 10 surrounded with foam stone (corresponding to an encompassing material) 2, and the mesh pot 10, encircled by a buoyant member 1, being floated by a culture solution 4 inside a water-tank unit 5, and meanwhile the culture solution 4 being aerated by an aerating ball 12 inside the water-tank unit 5. This is in order to resupply oxygen into the culture solution 4 by the aeration, given that if organic matter (algae) breeds within the culture solution 4, it will flourish in sunlight, leading to oxygen shortage throughout the culture solution 4 and encumbering growth of the roots 9 of the plant. Here, for the culture solution 4, Hyponex (brand name), for example, diluted in water is used, while the foam stone 2 is pumice or the like. Instead of the foam stone 2, however, glass fibers or the like, or another material that can serve as the encompassing material may be used.

The water-tank unit 5 is of regular rectangular form with an open-ended upper portion, and in a frame unit 14 provided on each of its sides, transparent glass panels 5a are respectively inset so as to constitute, except for the bottom side, all of the surrounding sides (front, rear, left, and right sides).

The buoyant member 1 is a somewhat flat, odd-shaped component that in plan view is of oblong form, and is dimensioned so as to be slightly larger than the opening defined by the frame unit 14 in the upper portion of the water-tank unit 5. The frame unit 14, in the uppermost portion of the water-tank unit 5, stops the buoyant member 1 from rising up any further, and functions as a stop means for preventing over tilting of the plant seedling 9. Also, in roughly the mid-portion of the buoyant member 1 in plan view, an opening 1a in the form of a round hole enabling the mesh pot to 10 to be inset in an upright posture is made.

As indicated in FIG. 3, the mesh pot 10 is rendered in the form of a frustum with its girth being larger than the growth pot 3a, and in the surrounding wall 10b and the bottom wall 10c, a number of perforations through which packed-in foam stone 2 cannot pass, but large enough that roots jutting out of the plant seedling 9 can pass, are formed. Further, on the brim of the mesh pot 10, a flange 10a is formed, with the flange 10a being interlocked with the opening 1a in the buoyant member 1 and formed such that the mesh pot 10 is unitary with the buoyant member 1.

Also, the outer side of the opening 1a in the buoyant member 1 assumes a two-ply structure, and the further outer side, a single-ply structure 1c. The two-ply structure 1b may be rendered a hollow component, or a component into which polystyrene foam is sealed. A buoyant member 1 of such configuration then takes on a form in which it is able to support the upper portion alone of the mesh pot 10. This is because if the mesh pot 10 is considerably tall by comparison to the buoyant member 1, its overall center of gravity will be high, making the buoyant member 1 prone to instability when it is floated on the culture solution 4.

As indicated in FIG. 4A, the peripheral side of the water-tank unit 5 is covered with an insulating members (corresponding to an opaque member) 5b, 5c that are opaque and light-shielding. By being light-shielding, the insulating member serves to keep organic matter from him developing, and its insulating action maintains the temperature within the water tank practically constant. Nevertheless, since the upper portion of the water-tank unit 5 is open-ended, it is covered with a lid 5d (corresponding to an opaque member) that is opaque and light-shielding. By being light-shielding, the lid serves to keep organic matter from him developing, and meanwhile prevents the foam stone from scattering and functions to support the stalk of the plant 9 so that it does not waver. That purpose has the lid 5d being split in two in approximately the middle, with the two halves being anchored through the buoyant member 1 by means of hinges 5e, forming a double-door construction. Likewise, the front side of the insulating member 5c is split in two down the approximate middle, adopting, with the two halves being on hinges not shown in the drawing, a double-door construction, wherein a glass window 5a inside thereof can be exposed. This is for the purpose of observing, among other things, how the roots of the plant 9 are spreading.

As represented in FIG. 4B, the insulating members 5b, 5c are components in which a thick sheet of polystyrene foam is sandwiched between two thin aluminum panels or the like. Although the lid 5d is the same, as indicated in FIG. 4C a soft block 5f made of glass fiber or the like is employed in the round hole in the lid 5d to fill the gap between the plant stalk 9 and the lid 5d, and at the same time so that the stalk 9 is not harmed. Here, it is preferable that a slit for insetting the stalk 9 be put into the block 5f, or that a rounded or similar form be lent the block where it touches the stalk 9. This is in order to remove any risk of injury to the stalk 9.

As illustrated in FIG. 1 and FIG. 2, the aerating ball 12, an air hose 7 connected to the aerating ball 12 via an air hose joint 8, an air pump 6 for supplying air to the air hose, and a power cord 13 for supplying electric power to the air pump 6 correspond to the air supply means.

In the following, a method of using the present hydroponic cultivation kit 100 will be described.

A growth pot 3a in which a commercial plant seedling 9 has been planted in soil is prepared. Then to begin with, a small amount of foam stone 2 is put into the mesh pot 10, in the midst of which the contents 3 taken out from the growth pot 3a are placed, and further foam stone 2 is put in around the stalk of the plant seedling 9 and atop the soil to anchor the plant seedling 9. At that time, the lid 5d is shut around it.

The mesh pot 10 is inset into the buoyant member 1. The aerating ball 12, connected by the air hose 7 with external air pump 6, is installed in the bottom portion of the water-tank unit 5, and the air hose 7 is anchored to the frame unit 14 of the water-tank unit 5 by the air hose joint 8. Then the insulating member 5b, 5c are fitted around the water-tank unit 5, while the front-side the insulating member 5c is left open.

Culture solution 4 is poured into the water-tank unit 5 to about the halfway level, the buoyant member 1 is put into the water-tank unit 5, and then culture solution 4 is poured into the water-tank unit 5 to adjust the amount of liquid. Herein, when culture solution 4 is poured into the water-tank unit 5, the buoyant member 1 is elevated and eventually abuts against the frame unit 14, where it stops. At that point, since the interior of the water-tank unit 5 has been filled with the culture solution 4 up to the maximum water level WL, the pouring is immediately halted. When the power cord 13 is connected to a not-illustrated power source to drive the air pump 6, air bubbles are generated. Such air-bubble generating can be observed through the front-side glass window 5a. The front-side insulating member 5c is shut. Thereafter, refilling with culture solution 4 is carried out. And by leaving the front-side insulating member 5c open, observation of the growth of the roots of the plant seedling 9, and similar observations can be made through the glass window 5a.

As described in the foregoing, according to present Embodying Mode 1, since a configuration is rendered such that contents 3 of a growth pot 3a in which a plant seedling 9 has been planted in soil are put, surrounded with foam stone 2, into a mesh pot 10, and the mesh pot 10, encircled by a buoyant member 1, is floated by culture solution 4 inside a water-tank unit 5, the plant seedling 9 can be taken out, as-is planted in soil, from the growth pot 3a and replanted. Risk of the plant roots 9 getting injured is thereby eliminated. Thus, as the plant roots 9 extend within the culture solution 4, the buoyant member 1 rises or falls with increase or decrease of the culture solution 4, whereby the present amount of culture solution 4 can be known. Then at an appropriate timing, the culture solution 4 can be supplemented. A benefit in configuring in this way is that the transformation in the growing of the plant seedling 9 can be observed directly and easily.

### Embodying Mode 2

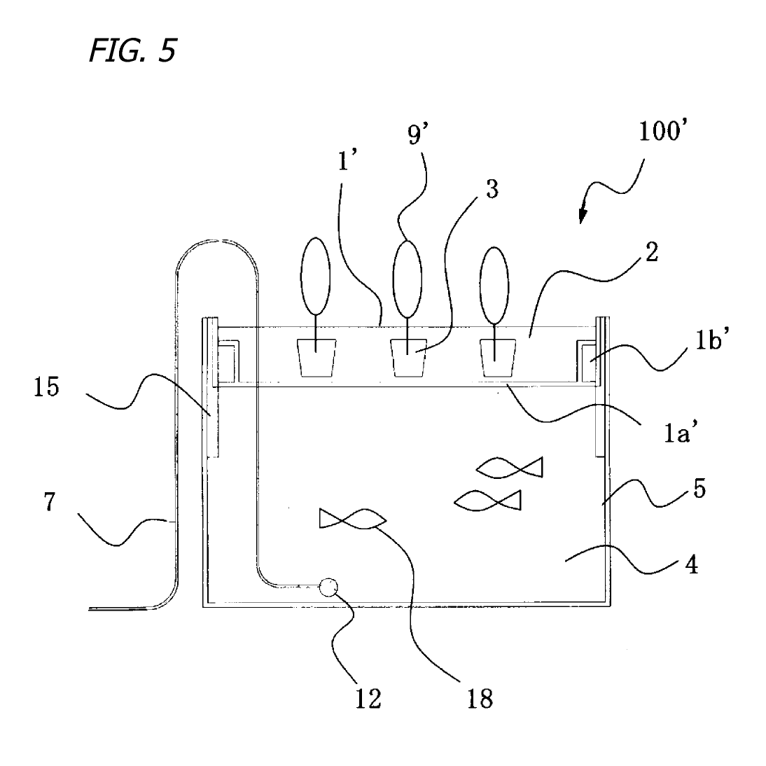

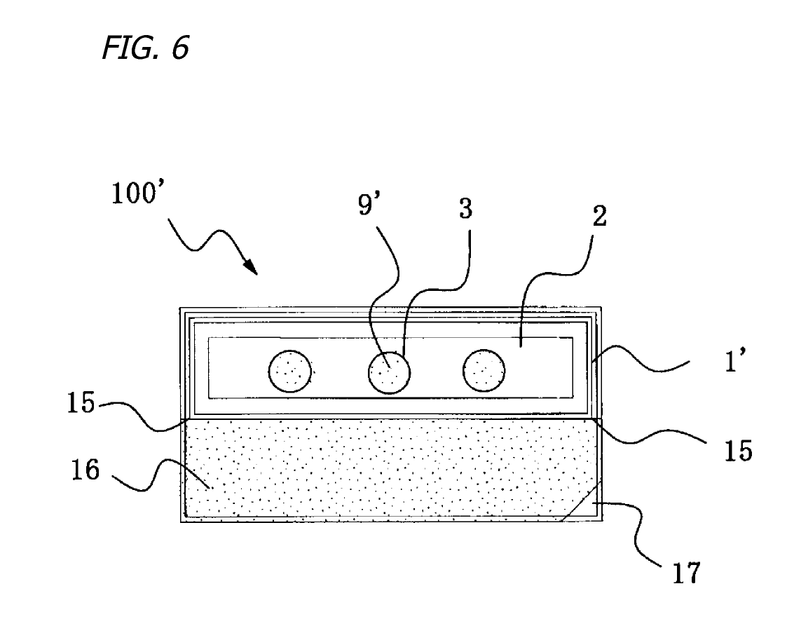

It will be appreciated that while with Embodying Mode 1 it was that raising of a single plant seedling 9 is observed, there will be situations in which it is desired to enjoy viewing a plurality of decorative plants from cuttings 9′, 9′, . . . , as well as fish 18, 18, . . . . FIG. 5 is a front view illustrating the overall configuration of a hydroponic cultivation kit 100′ involving Embodying Mode 2 of the present invention, and FIG. 6 is a plan view thereof. It should be understood that in present Embodying Mode 2, elements that are in common with above-described in Embodying Mode 1 are labeled with the same reference marks, and redundant description thereof will be omitted to the extent possible.

The hydroponic cultivation kit 100′, as indicated in FIG. 5 and FIG. 6, features growth-pot 3a contents 3, 3, . . . that are, instead of the plant seedling 9 of Embodying Mode 1, in-soil decorative plants 9′, 9′, . . . made from cuttings, surrounded with foam stone (corresponding to an encompassing material) 2, with the foam stone 2, further encircled by a buoyant member 1′, being floated by the culture solution 4 within the water-tank unit 5, and meanwhile the culture solution 4 being aerated by the aerating ball 12 inside the water-tank unit 5. This aerating is done in order for the fish 18, 18, . . . to breathe.

As indicated in FIG. 6, the buoyant member 1′ in plan view assumes the form of a long rectangle in which the mid-portion and proximity is sunken, and is dimensioned slightly smaller than the far half of the opening in the upper portion of the water-tank unit 5. And the near half of the opening in the upper portion of the water-tank unit 5 is covered by a flat, platelike lid 16. At the border between the buoyant member 1′ and the lid 16, a swing-stop 15 for the buoyant member 1′ is provided, and the right-hand front of the lid 16 is partially notched, forming a feed delivery port 17 in the form of a triangle.

As indicated in FIG. 5, the buoyant member 1′ assumes a boxlike form in lateral section view, with the bottom being a single-walled structure 1a′ and its perimeter, a double-walled structure 1b′. The single-walled structure 1a′ is composed of so-called pegboard (corresponding to a retaining member), and is a component in which are formed a plurality of perforations of size such that the foam stone 2 packing the inside cannot pass through, while the roots of the decorative plants 9′, 9′, . . . can pass through. This mode has the double walled structure 1b′ be hollow or have polystyrene foam sealed into it. Further, the swing-stops 15, 15 for the buoyant member 1′ are in two locations on the left/right in the approximate center in the front-to-rear orientation of the water-tank unit 5, and are of vertical platelike form each constituted from the top edge to about a midway depth. Thus, with a buoyant member 1′ of such configuration, the lid 16 is supported free to rise and fall. The buoyant member 1′ of such configuration has a center of gravity considerably lower than in the case of Embodying Mode 1, such that its stability when floated in the culture solution 4 is favorable, so that the double walled structure 1b′ does not necessarily have to be provided in the upper portion as in Embodying Mode 1. And since the swing-stops 15, 15 restrict tilting of the buoyant member 1′ and lid 16, it is also unnecessary to abut the buoyant member 1′ on the frame unit 14 of the water-tank 5 as in Embodying Mode 1.

As indicated in FIG. 5 and FIG. 6, the aerating ball 12 that supplies air into the culture solution 4, the air hose 7 connected to the aerating ball 12, etc. correspond to an air supply means.

In the following, a method of using the present hydroponic cultivation kit 100′ will be described.

Herein, growth pot(s) 3a with in-soil decorative plants 9′, 9′, . . . made from cuttings are prepared. Then to begin with, a small amount of foam stone 2 is put into the buoyant member 1′, and into the interior thereof, contents 3, 3, . . . taken out of the growth pot(s) 3a are placed, further foam stone 2 is inserted, anchoring the decorative plants 9′, 9′, . . . from cuttings.

The aerating ball 12, connected by means of the air hose 7, is placed in the bottom potion of the water-tank unit 5.

Culture solution 4 is poured inside the water-tank unit 5 to about the halfway level, the swing-stops 15, 15 are fitted into a slit provided in between the buoyant member 1′ and the lid 16 and put into the water-tank unit 5, and then culture solution 4 is poured inside the water-tank unit 5 to adjust the amount of liquid. Herein, pouring culture solution 4 inside the water-tank unit 5 elevates the buoyant member 1′, and when the tank-unit 5 interior is filled with the culture solution 4, the pouring-in of the solution is halted. Driving a not-illustrated air pump generates air bubbles. Such air-bubble generating can be observed through the front-side glass window 5a. Therein, fish 18, 18, . . . are reared by putting them into the culture solution 4 within the water-tank 5. Thereafter, through the feed-delivery port 17 in the buoyant member 1′, feed for the fish 18, 18, . . . is tossed in at appropriate times. Further, through the glass window 5a, the fish 18, 18, . . . can be pleasurably viewed, in addition to the growth of the roots of the decorative plants 9′, 9′, . . . .

As described in the foregoing, since the configuration is such that growth-pot 3a contents 3, 3, . . . that are decorative plants 9′, 9′, . . . made from in-soil cuttings are surrounded with foam stone 2 that is further encircled by the buoyant member 1′ floated by the culture solution 4 within the water-tank unit 5, the decorative plants 9′, 9′, . . . can be taken out from the growth pot(s) 3a intact as in-soil cuttings and replanted. Risk of injury to the decorative plant roots 9′, 9′, . . . is thereby eliminated. Thus, with these decorative plants, as the roots 9′, 9′, . . . extend within the culture solution 4, the buoyant member 1′ and lid 16 rise or fall with the increase or decrease of the culture solution 4, whereby the present amount of culture solution 4 can be known. Then at an appropriate timing the culture solution 4 can be supplemented, and the feed for the fish 18, 18, . . . can be tossed in. A benefit in configuring in this way is that it facilitates appreciation of the decorative plants 9′, 9′, . . . and the fish 18, 18, . . . .

It should be understood that with earlier-described Embodying Mode 1, the growth pot 3a that is used is one in which a single type of plant seedling 9 has been planted in soil, while with above-described Embodying Mode 2, the growth pot(s) 3a that is used is one in which are a plurality of decorative plants 9′, 9′, . . . made from in-soil cuttings, and fish 18, 18, . . . are raised, but it is a matter of course these may be combined to suit.

Also, with earlier-described Embodying mode 1, a portion of the insulating members 5b, 5c was split in two, leaving them free to be opened in a double-door construction, but a portion or the entirety thereof may be rendered free to open/close by means of a single-swinging or sliding door(s), or may be made detachable/reattachable. This is likewise the case with regard to the lid 5d. Furthermore instead of the insulating members 5b, 5c, opaque light-shielding material is an option. This is likewise the case with regard to the lid 5d.

Furthermore, with above-described Embodying Mode 2, the configuration was not fitted out with the insulating members 5b, 5c or the lid 5d, but the configuration may be fitted out in the same manner as with Embodying Mode 1.

Also, with above-described Embodying Modes 1 and 2, the power source for the air pump 6 is not particularly limited, but a solar power source, for example, may be employed, serving to save energy.

In addition, with above-described Embodying Modes 1 and 2, as the retaining member the mesh pot 10 or the pegboard was employed but a slit structure or the like may also be employed.

Further, with above-described Embodying Modes 1 and 2, the buoyant members 1 and 1′ were furnished with a double-wall structure 1b, 1b′, which was either hollow or had have polystyrene foam sealed into it, but the entire team may be composed of polystyrene foam sealed.

A hydroponic cultivation kit of the present invention can be produced in volume as a hydroponic cultivation kit for home gardening, and therefore has industrial efficacy.

### DESCRIPTION OF REFERENCE MARKS

100, 100′: hydroponic cultivation kit
1, 1′: buoyant member
2: foam stone (corresponding to an encompassing material)
3: growth-pot contents (soil, etc.)
3a: growth pot
4: culture solution
5: water-tank unit
5a: glass window
5b, 5c: insulating members (corresponding to an opaque member)
5d: lid (corresponding to an opaque member)
5e: frame unit (corresponding to a stop means)
5f: block
6: air pump (corresponding to air-supply means)
7: air hose (corresponding to air supply means)
8: air-hose joint (corresponding to air supply means)
9: plant (seedling, stalk, roots thereof)
9′: decorative plants (cuttings, roots thereof)
10: mesh pot (corresponding to a retaining member)
11: water supply/discharge port
12: aerating ball (corresponding to air supply means)
14: frame unit (in particular, uppermost component corresponding to a
stop means)
15: swing stop
16: lid
17: feed delivery port
18: fish

1. A hydroponic cultivation kit for cultivating in a culture solution a soil-clung plant—being, within a growth pot prepared in advance, a plant seedling planted in soil or an in-soil decorative plant from a cutting—taken out of the growth pot together with the soil, the hydroponic cultivation kit comprising:
an encompassing material for surrounding the soil periphery of the plant taken out from the growth pot;
a retaining member for retaining the plant with its soil periphery surrounded by the encompassing material, the retaining member having perforations such as to prohibit the encompassing material from passing through it, yet meanwhile permit passage of roots jutting out from the plant; and
a buoyant member for floating the retaining member in culture solution inside a water-tank unit.

2. The hydroponic cultivation kit set forth in claim 1, characterized in that the buoyant member is able to support an upper portion alone of the retaining member.

3. The hydroponic cultivation kit set forth in claim 1, characterized in that a stop means for staying the buoyant member is provided in an upper portion of the water-tank unit.

4. The hydroponic cultivation kit set forth in claim 1, characterized in being provided with an air supply means for supplying air into the culture solution.

5. The hydroponic cultivation kit set forth in claim 1, characterized in that the water-tank unit is enclosed in an opaque member, and in that the opaque member along at least a front face of the water-tank unit is either removable or is openable/closable.

6. The hydroponic cultivation kit set forth in claim 1, characterized in that an upper face of the retaining member is covered with a dual-split lid, and in that the lid is furnished with a soft block that allows a plant stalk to penetrate therethrough.

7. The hydroponic cultivation kit set forth in claim 1, characterized in that fish rearing within the culture solution inside the water-tank unit is enabled.
